(19) United States
(12) Patent Application Publication
(10) Pub. No.: US 2017/0210002 A1
(43) Pub. Date: Jul. 27, 2017

(54) Women's Tool Kit

(71) Applicants: Teresa Turner, Fort Worth, TX (US); Reanna Mendenhall, Fort Worth, TX (US)

(72) Inventors: Teresa Turner, Fort Worth, TX (US); Reanna Mendenhall, Fort Worth, TX (US)

(21) Appl. No.: 15/006,328

(22) Filed: Jan. 26, 2016

(51) Int. Cl. B25H 3/02; A45C 13/26; B65D 43/16; G01C 9/00; B25D 1/06; B25F 5/02; G01B 3/10; A45C 13/10; B65D 25/04

(52) U.S. Cl. CPC B25H 3/02; A45C 13/103; A45C 13/26; B65D 43/16; B65D 25/04; B25D 1/06; B25F 5/02; G01B 3/10; G01C 9/00

(57) ABSTRACT

A women's tool kit facilitates use of tools by women. The kit includes a perimeter wall coupled to and extending from a bottom panel defining an interior space of a container. The container includes a top panel pivotally coupled to the perimeter wall to cover the interior space. A medial section of the top panel is clear such that the interior space is visible through the top panel when the top panel covers the interior space. Interior walls define a plurality of compartments within the interior space. Each of a plurality of tools is positionable within an associated one of the compartments. The tools include a plurality of hand held tools sized to fit an average woman's hand size. Instruction media is positionable in the container providing instructions on proper use of each of the tools.

### BACKGROUND OF THE DISCLOSURE

### Field of the Disclosure

The disclosure relates to tool kits and more particularly pertains to a new tool kit for facilitating use of tools by women.

### SUMMARY OF THE DISCLOSURE

An embodiment of the disclosure meets the needs presented above by generally comprising a perimeter wall coupled to and extending from a bottom panel defining an interior space of a container. The container includes a top panel pivotally coupled to the perimeter wall to cover the interior space. A medial section of the top panel is clear such that the interior space is visible through the top panel when the top panel covers the interior space. Interior walls define a plurality of compartments within the interior space. Each of a plurality of tools is positionable within an associated one of the compartments. The tools include a plurality of hand held tools sized to fit an average woman's hand size. Instruction media is positionable in the container providing instructions on proper use of each of the tools.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an exploded top front side perspective view of a women's tool kit according to an embodiment of the disclosure.

FIG. 2 is a bottom view of a container of an embodiment of the disclosure.

FIG. 3 is a top view of a container of an embodiment of the disclosure.

FIG. 4 is a detailed top back side perspective view of a hammer of an embodiment of the disclosure.

### DESCRIPTION OF THE PREFERRED EMBODIMENT

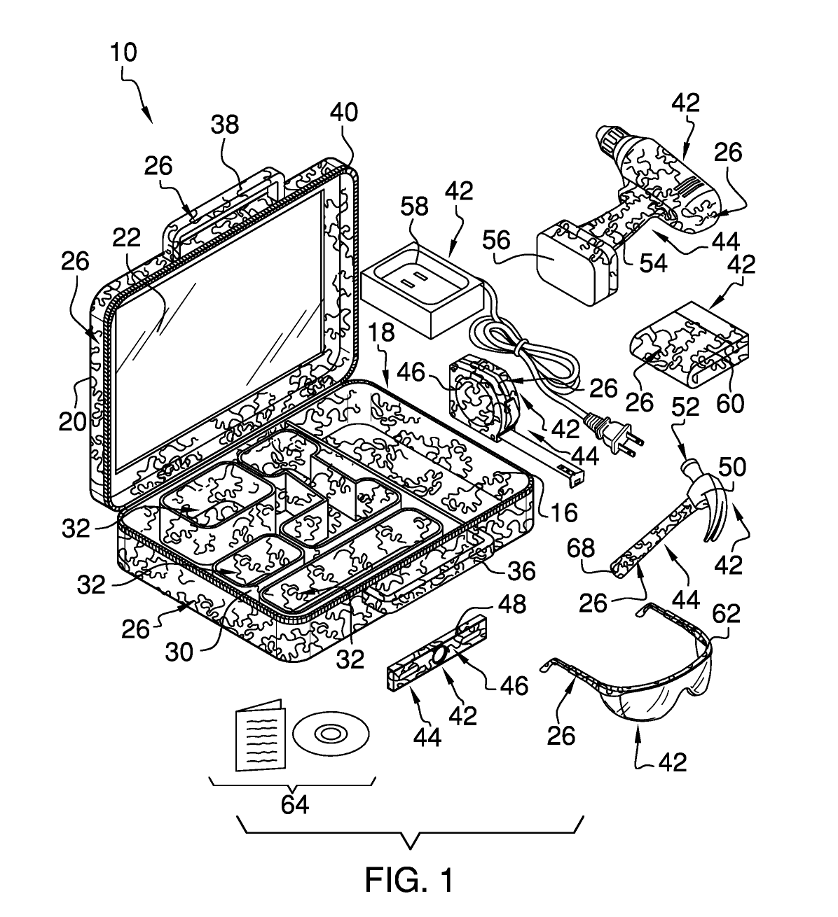

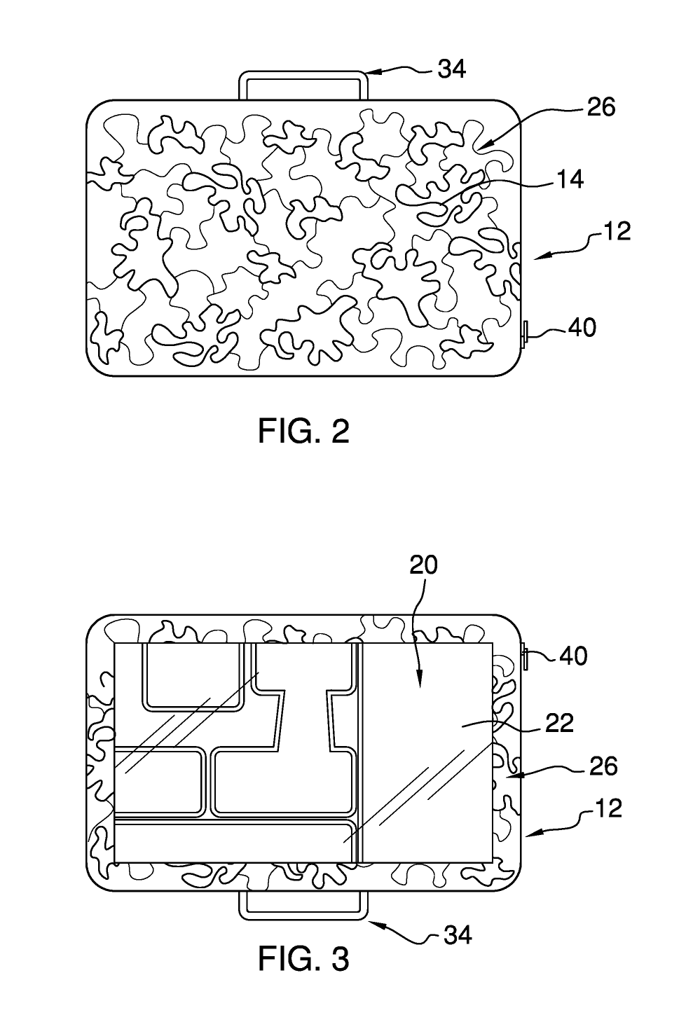

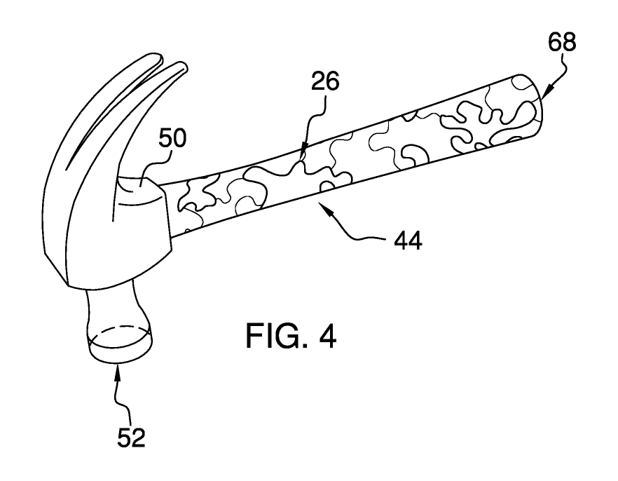

With reference now to the drawings, and in particular to FIGS. 1 through 4 thereof, a new tool kit embodying the principles and concepts of an embodiment of the disclosure and generally designated by the reference numeral 10 will be described.

As best illustrated in FIGS. 1 through 4, the women's tool kit 10 generally comprises a container 12. The container 12 has a bottom panel 14 and a perimeter wall 16 coupled to and extending from the bottom panel 14 defining an interior space 18 of the container 12. The container 12 includes a top panel 20 pivotally coupled to the perimeter wall 16 such that the top panel 20 selectively covers the interior space 18. A medial section 22 of the top panel 20 is sufficiently clear, being transparent or translucent, such that the interior space 18 is visible through the medial section 22 of the top panel 20 when the top panel 20 covers the interior space 16. The bottom panel 14 is opaque and the perimeter wall 16 is also opaque. Respective outer surfaces of the bottom panel 14 and perimeter wall 16 have indicia comprising a pink camouflage pattern 26. The container 12 includes a plurality of interior walls 30 defining a plurality of compartments 32 within the interior space 16. The interior walls 30 also include the pink camouflage pattern 26. Alternatively, a brown camouflage pattern may be used. A handle 34 is coupled to the container 12. The handle 34 may have a first section 36 coupled to the perimeter wall 16 and a second section 38 coupled to the top panel 20. The first section 38 aligns with the second section 38 to facilitate carrying the container 12. A zipper 40 is coupled to the perimeter wall 16 and the top panel 20 wherein the zipper 40 selectively couples the top panel 20 to the perimeter wall 16 to secure the top panel 20 while covering the interior space 16. The container 12 is constructed of a flexible and durable fabric material such as the synthetic polymer nylon or the like.

Each of a plurality of tools 42 is provided. Each of the tools 42 is positionable within an associated one of the compartments 32 wherein the container 12 is configured for holding the tools 42 to be carried by a person. Each of the plurality of tools 42 of the kit 10 has patterned indicia thereon. The patterned indicia comprises the pink camouflage pattern 26 providing a cohesive visual appearance with the container 12. The tools 42 include a plurality of hand held tools 44 as a subset of the tools 42 generally. Each of the hand held tools 44 is sized such that the hand held tools 44 are configured to fit an average woman's hand size which is smaller than the average man's hand size for which conventional tools are currently designed. The average woman's hand size is approximately 170 to 175 millimeters in length and 70 to 75 millimeters in width. By comparison, the average man's hand size is approximately 185 to 190 millimeters in length and 80 to 85 millimeters in width. The hand held tools 44 include a measuring tape 46 and a level 48. The hand held tools 44 further include a hammer 50. The hammer 50 has a magnetic striking face 52 and a magnetic distal end 68 relative to the striking face 52. The distal end 68 may be used to magnetically hold a plurality of nails on the hammer 50 until they are ready to be driven using the hammer 50. The hand held tools 44 include a drill 54. The drill 54 is powered by a rechargeable battery 56. The tools 42 include a battery charger 58. The rechargeable battery 56 is coupleable to the battery charger 58 for charging the rechargeable battery 56. The tools 42 also include a drill accessory pouch 60 which may hold a plurality of conventional drill bits and attachments of conventional design. The drill bits and attachments are of conventional design and may be magnetized in a conventional manner to assist in attachment and use of the drill bits and attachments. The tools 42 also include safety glasses 62 which are similarly scaled down in size to fit an average woman's head size as compared to an average man's head size.

Instruction media 64 is provided with the kit 10. The instruction media 64 may be written or presented in a recorded audio and/or video format such as in a digital video disc format. Alternatively or in combination with a digital video disc, the instruction media 64 may comprise a link to a web site providing instructional videos, written instructions, and the like. The instruction media 64 is positionable in the container 12 with the tools 42. The instruction media 64 provides instructions on proper use of each of the tools 42.

In use, the kit 10 provides a compact set of the tools 42 and instruction media 64 to teach proper and safe use of each of the tools 42. The scaled size of the tools 44 within the kit 10, pink camouflage pattern 26, and instruction media 64 provide a unintimidating atmosphere for women previously unfamiliar with the tools 42 to begin working with the kit 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A women's tool kit comprising:
a container, said container having a bottom panel and a perimeter wall coupled to and extending from said bottom panel defining an interior space of said container, said container including a top panel being pivotally coupled to said perimeter wall such that said top panel selectively covers said interior space, a medial section of said top panel being clear such that said interior space is visible through said top panel when said top panel covers said interior space, said container including a plurality of interior walls defining a plurality of compartments within said interior space;
a plurality of tools, each of said tools being positionable within an associated one of said compartments wherein said container is configured for holding said tools to be carried by a person, said tools including a plurality of hand held tools, each of said hand held tools being sized such that said tools are configured to fit an average woman's hand size; and
instruction media, said instruction media being positionable in said container with said tools, said instruction media providing instructions on proper use of each of said tools.

2. The kit of claim 1, further comprising said bottom panel being opaque and said perimeter wall being opaque.

3. The kit of claim 1, further comprising said hand held tools including a hammer.

4. The kit of claim 3, further comprising said hammer having a magnetic striking face.

5. The kit of claim 1, further comprising each of said plurality of tools of said kit having patterned indicia thereon, said patterned indicia comprising a pink camouflage pattern.

6. The kit of claim 1, further comprising a handle coupled to said perimeter wall.

7. The kit of claim 1, further comprising said hand held tools including a measuring tape.

8. The kit of claim 1, further comprising said hand held tools including a drill.

9. The kit of claim 8, further comprising a rechargeable battery, said drill being powered by said rechargeable battery.

10. The kit of claim 9, further comprising said tools including a battery charger, said rechargeable battery being coupleable to said battery charger for charging said rechargeable battery.

11. The kit of claim 1, further comprising said hand held tools including a level.

12. The kit of claim 8, further including said tools including a drill accessory pouch.

13. The kit of claim 1, further comprising said tools including safety glasses.

14. The kit of claim 1, further comprising a zipper coupled to said perimeter wall and said top panel wherein said zipper selectively couples said top panel to said perimeter wall to secure said top panel while covering said interior space.

15. A women's tool kit comprising:
a container, said container having a bottom panel and a perimeter wall coupled to and extending from said bottom panel defining an interior space of said container, said container including a top panel being pivotally coupled to said perimeter wall such that said top panel selectively covers said interior space, a medial section of said top panel being clear such that said interior space is visible through said top panel when said top panel covers said interior space, said bottom panel being opaque, said perimeter wall being opaque, said container including a plurality of interior walls defining a plurality of compartments within said interior space;
a handle coupled to said perimeter wall;
a zipper coupled to said perimeter wall and said top panel wherein said zipper selectively couples said top panel to said perimeter wall to secure said top panel while covering said interior space;
a plurality of tools, each of said tools being positionable within an associated one of said compartments wherein said container is configured for holding said tools to be carried by a person, each of said plurality of tools of said kit having patterned indicia thereon, said patterned indicia comprising a pink camouflage pattern,
said tools including a plurality of hand held tools, each of said hand held tools being sized such that said hand held tools are configured to fit an average woman's hand size, said hand held tools including a measuring tape, said hand held tools including a level, said hand held tools including a hammer, said hammer having a magnetic striking face, said hand held tools including a drill, said drill being powered by a rechargeable battery, said tools including a battery charger, said rechargeable battery being coupleable to said battery charger for charging said rechargeable battery, said tools including a drill accessory pouch, said tools including safety glasses; and
instruction media, said instruction media being positionable in said container with said tools, said instruction media providing instructions on proper use of each of said tools.
